(19) United States
(12) Patent Application Publication
(10) Pub. No.: US 2004/0093269 A1
(43) Pub. Date: May 13, 2004

(54) Multi-level sales and marketing methodology for the internet

(76) Inventors: Wayne Rubin, Woodmere, NY (US); Scott Landress, Mill Valley, CA (US)

Correspondence Address: OSTROLENK FABER GERB & SOFFEN, 1180 AVENUE OF THE AMERICAS, NEW YORK, NY, 100368403

(21) Appl. No.: 10/696,053

(22) Filed: Oct. 28, 2003

Related U.S. Application Data
(63) Continuation of application No. 09/569,180, filed on May 11, 2000, now abandoned.

(51) Int. Cl. G06F 17/60

(52) U.S. Cl. 705/14

(57) ABSTRACT

A unified, flexible, extensible, distributed multi-level purchasing, sales and marketing methodology for companies conducting business on the Internet. A Participant in the present invention registers with a Host/Hub and an account is established for the Participant. As Participants perform certain activities such as purchases, surfing or viewing ads with respect to the Host/Hubs and its commercial Partners, the Participants are awarded “credits” that are credited to the Participant's bank accounts. The “credits” in a Participant's account can be used for a variety of purposes such as credits for new purchases, bill payment, micro-payments and cash redemption. Participants are additionally rewarded credits on the basis of the point generating activities performed by each new Participant signed up by the original Participant, and each subsequent Participant signed up by the new participant. This multi-level marketing approach to Internet commerce is accomplished by linking the accounts of the related Participants. As lower level Participants receive credits, a portion of the those credits are credited to the account of the higher level Participants.

### CROSS-REFERENCE TO RELATED APPLICATION

This application is based on and claims priority to U.S. patent application Ser. No. 09/569,180 filed May 11, 2000, entitled “MULTI-LEVEL SALES AND MARKETING METHODOLOGY FOR THE INTERNET,” the entire contents of which are expressly incorporated herein by reference.

### FIELD OF THE INVENTION

The present invention generally relates to marketing and sales methodology and more particularly to a sales and marketing methodology for the Internet that employs multi-level techniques.

### BACKGROUND OF THE INVENTION

There are several marketing methods currently being practiced which reward consumers (individuals and businesses) for certain activities which they perform on the Internet. In the majority of these methods, consumers register with a service and are rewarded points, cash or other rewards for performing certain defined actions while visiting various sites on the Internet.

One such system is known as beenz (www.beenz.com) In the beenz system, consumers register at the Internet site of the system provider and have an account established for the consumer. As the consumer visits partners of the system provider, he or she collects “beenz” (points) at the site which are added to the consumer's account. Sometimes the “beenz” are collected merely for visiting the site and sometimes the “beenz” must be earned by performing some action, such as making a purchase at the site.

A similar system is offered by Netcentives (www.netcentives.com) which awards consumers mileage points to consumers for engaging in certain promotions (e.g., purchases). Mypoints offers a service (www.mypoints.com) in which consumers can earn points by shopping, reading email, filling out surveys, web surfing and filling out surveys. Mypoints participants receive a one time bonus of points for friends that the participant refers to the system if the friend registers for the service. The Alladvantage service (www.alladvantage.com) rewards consumers with cash for the amount of time they spend visiting sites on the Internet. Similar to Mypoints, Alladvantage rewards cash to consumers who refer other to the service. In the Alladvantage system, a participant receives a reduced amount of cash for the time the referred participant spends visiting online sites. The original participant receives a further reduced amount for the surfing time spent by extended referral participants (referrals of the participant that was introduced by the original participant). The Alladvantage system only rewards participants for surfing time and is not a comprehensive rewards system which generates cumulative marketing or purchasing power either to the service provider or the consumers.

Mercata (www.mercata.com) provides a service in which consumers agree to purchase an item for sale offered on the system operated by Mercata. As more consumers agree to buy the same product, the price for the product to each consumer is reduced. The offer for sale is time limited and once the time has expired, the consumers must pay the finally established sales price. Prio (www.prio.net) offers a service in which a consumers registers with the service and identifies a credit card. As the consumer uses his or her credit card at participating merchants, the credit card is credited with a cash back reward.

Although each of the above described systems have certain appealing features, none of them offer a comprehensive multilevel marketing method and system that enables aggregation of customer identification, demographic, attitudinal and behavioral information, and enables aggregation of purchasing, selling and marketing power to capture cooperative economies of scale and size, all as may lead to or produce savings revenue or other marketing benefits. Furthermore, most of the prior art systems require the user to spend the points or credits in a certain fashion (e.g., credit towards a purchase) rather than letting the customer use its credits anywhere anytime.

### SUMMARY OF THE INVENTION

The present invention provides a unified, flexible, extensible, distributed multilevel purchasing, sales and marketing methodology for companies conducting business on the Internet. The entity administering the system and methods of the present invention is known herein as a Host/Hub, and the Internet merchants and service providers participating in the program are known as Partners. Consumers (individuals and businesses) desiring to participate in the method of the present invention register with at least one Host/Hub. The consumers are then designated as Participants, and “bank” accounts are established for each of the Participants. As Participants perform Qualified Activities with respect to the Host/Hubs and Partners, the Participants are awarded credits that are stored in the Participant's account. Qualified Activities can include, for example, making purchases at Partners, visiting Partners, sending invitations to other consumers inviting them to become Participants, signing up new Participants, viewing advertising and participating in marketing surveys and polls. The credits in a Participant's account can be used for a variety of purposes such as credits for new purchases, bill payment, micro-payments and cash redemption.

A significant aspect of the present invention is that Participants are rewarded credits on the basis of the Qualified Activities performed by each new Participant signed up by the original Participant, and each subsequent Participant signed up by the new participant. This multi-level marketing approach to Internet commerce is accomplished by linking the accounts of the related Participants. For example, the account of the original Participant (first level Participant) is linked to the accounts of each of the referred Participants (second level Participants) signed up by the first level Participant. The accounts of subsequent Participants (third level Participants) are linked to the respective second level Participants that signed them up. In this manner, as credits are awarded to accounts of the third level Participants, some percentage of those credits flow up to the accounts of the second level Participants, and in turn, some percentage of those credits may flow up to the first level Participants.

The present invention provides tangible benefits to the Partner companies by attracting and retaining customers and motivating customers to engage in certain activities including, but not limited to purchases of goods and services, the viewing and interaction with marketing, advertising or promotions or the introduction of new consumers to the method. The present invention further promotes customer loyalty through fully fungible reward programs, enables aggregation of customer identification, demographic, attitudinal and behavioral information, and enables aggregation of purchasing, selling and marketing power to capture cooperative economies of scale and size, all as may lead to or produce savings revenue or other marketing benefits.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 illustrates the system of the present invention;

FIG. 2 illustrates the crediting of credits to the accounts of Participants;

FIG. 3 depicts the multilevel structure of the Participants in the present invention;

FIG. 4 illustrates an example of point sharing according to the present invention; and

FIG. 5 illustrates a Micro-payment and point redemption embodiment of the present invention.

### DETAILED DESCRIPTION OF THE INVENTION

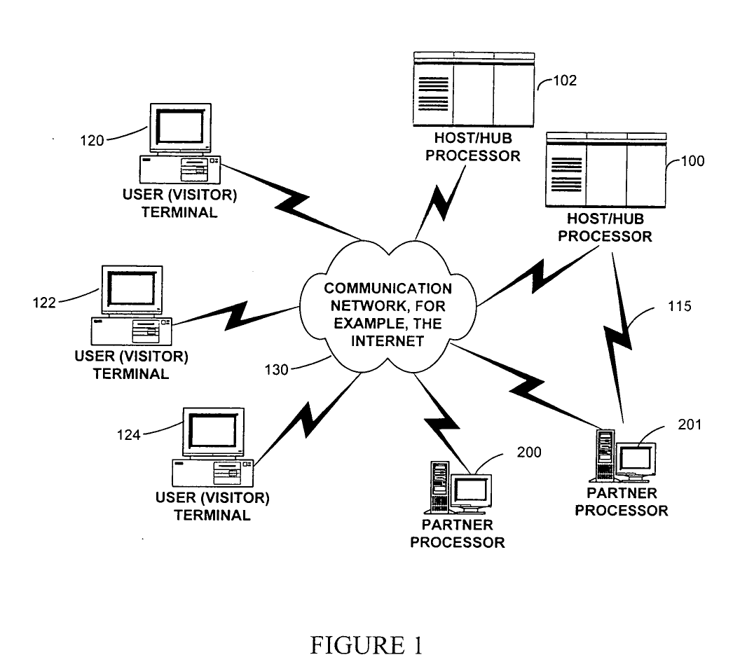

FIG. 1 illustrates the various parties to and components of the system of the present invention. In the preferred embodiment, communication between the various parties occurs through the Internet 130, although other means for communications can be employed such as a private value added network. FIG. 1 illustrates two different Host/Hub processing systems 100, 102. As will be further described below, the Host/Hub processors 100, 102 are responsible for administering the marketing and sales methods of the present invention. Although only a single Host/Hub (100 or 102) is necessary to practice the present invention, two processing systems 100, 102 have been shown to illustrate that several Host/Hubs 100, 102 can operate simultaneously. For example, one Host/Hub 100 can service consumer operations, while the second Host/Hub 102 can service business to business operations. Alternatively, all of the operations can be consolidated onto a single Host/Hub (100 or 102).

Elements 200, 201 represent the processors maintained by or on behalf of the Partners. The Partners are preferably merchants conducting commerce or advertisers conducting marketing on the Internet 130, but can be any other party that would benefit from the methods of the present invention. For example, a company that performs marketing surveys or polls would equally benefit from the present invention as it would attract traffic to the web site maintained by the survey company. The processors 200,201 preferably host web sites of the Partners on the Internet 130 using standard web site techniques. Although most of the communications between the parties is conducted on the Internet 130, certain communications between the Partners and the Host/Hub 100, 102 (e.g., sensitive financial information) can be transmitted via other secure communication media 115 (e.g., private network, dial-up lines . . . ). Elements 120-124 represent the devices by which the users (consumers, businesses, etc.) communicate with the Host/Hub 100, 102 and Partner processors 200, 201. The user terminals 120-124 can be Personal Computers (PCs), Personal Digital Assistants (PDAs), Internet Appliances, cellular telephones or any other devices that enable the user to connect to the communication network 130 (e.g., the Internet).

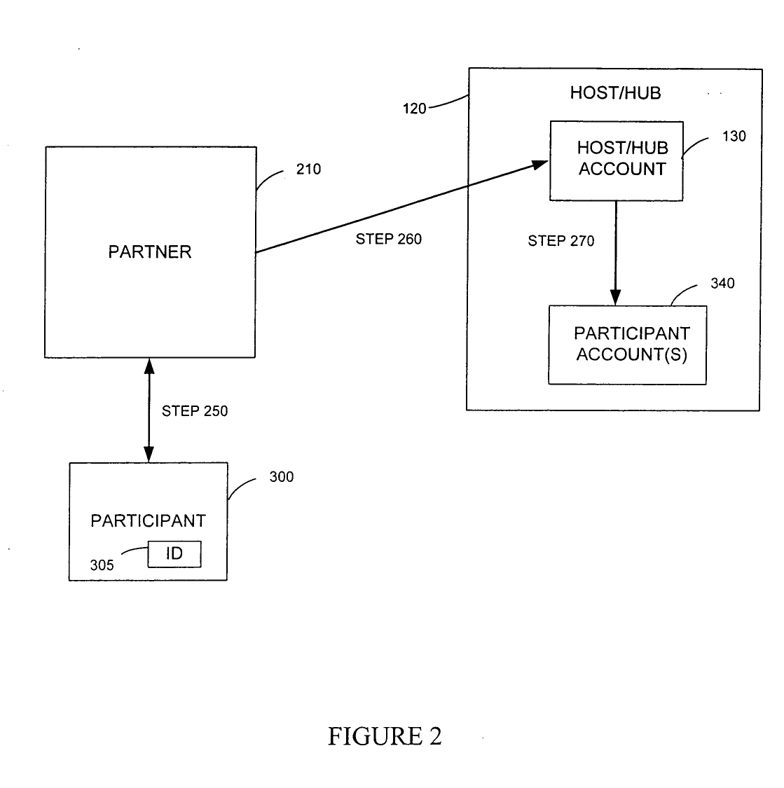

FIG. 2 illustrates one of the basic methods of the present invention, the crediting of credits to the account 340 of a Participant 300 as the Participant 300 performs a Qualified Activity. The entities illustrated in FIG. 2, Participant 300, Partner 210 and Host/Hub 120, correspond respectively to the components 120-124, 200-201 and 100-102 illustrated in FIG. 1. Prior to the process depicted in FIG. 2, the Participant 300 has registered with the Host/Hub 120 in order to participate in the method of the present invention. During this enrollment (registration) process, a Participant Account 340 is established for the Participant 300, and the Participant 300 is issued an identification (ID) 305 by which it can identify itself as a participant to a Partner 210. The Participant Account 340 contains the credits earned by the Participant 300 in accordance with the present invention. Furthermore, prior to the illustration of FIG. 2, the Partner 210 has contractually arranged with the Host/Hub 120 to take part in the methods and system of the present invention.

FIG. 2 illustrates an embodiment of the present invention in which the Participant 300 earns credits by making purchases from the Partner 210. In one embodiment, the Participant 300 navigates to the web site of the Partner 210 from a web site maintained by the Host/Hub 120. The Host/Hub 120 web site contains links to all of the Partners 210 participating in the system. Although only a single partner 210 has been illustrated in FIG. 2, it is appreciated that a plurality of Partners 210 can participate in the system and methods of the present invention. Similarly, there are a plurality of Participants 300 having a corresponding plurality of Accounts 340 at the Host/Hub 120. Alternatively, the Participant 300 can navigate to the web site of the Partner 210 on its own. In step 250, the Participant 300 and the Partner 210 complete a purchase. For example, the Participant 300 might purchase a camera for $100 from the Partner 210. As part of completing this purchase, the Participant 300 uses its ID 305 to identify itself as a participant in order to receive the credits for making the purchase. Once the purchase has been completed, the Partner 210 notifies the Host/Hub 120 of the purchase and forwards a portion of the purchase price to Host/Hub 120 in accordance with the agreement previously established between the Partner 210 and the Host/Hub 120. As part of the transaction between the Partner 210 and the Participant 300, the Partner 210 verifies the Participant's ID 305 with the Host/Hub 120.

The agreement between the Partner 210 and the Host/Hub 120 establishes the portion of the purchase price that will be provided to the Host/Hub 120. In a preferred embodiment, the portion given to the Host/Hub 120 by the Partner 210 is a percentage of the purchase price. For example, in the $100 camera purchase described above, the Partner 210 might be obligated to give the Host/Hub 120 ten percent of the purchase price, in other words $10. Any legal agreement by which the Host/Hub 120 shares in the revenues of the Partner 210 for activities by Participants 300 is possible. For example, the percentages given the Partner 210 to the Host/Hub 120 can be fixed or variable depending on the dollar value of particular purchases or the volume of sales made by the Partner 210 to Participants 300. In another embodiment, the Partner 210 can be obligated to pay the Host/Hub 120 a fixed amount for each Qualified Activity. For example, in the marketing survey example given above, the survey company may pay the Host/Hub 120 a fixed rate of $10 for each survey completed by a Participant 300. In an alternative business to business relationship, a purchasing business may have a sliding scale arrangement in which the number of credits awarded to the business (and the percentage provided to Host/Hub 120 from Partner 210) is determined on a scale. For example, the first $100,000 of purchases results in a fixed number of credits and any purchases above the $100,000 figure results in a reduced number of credits.

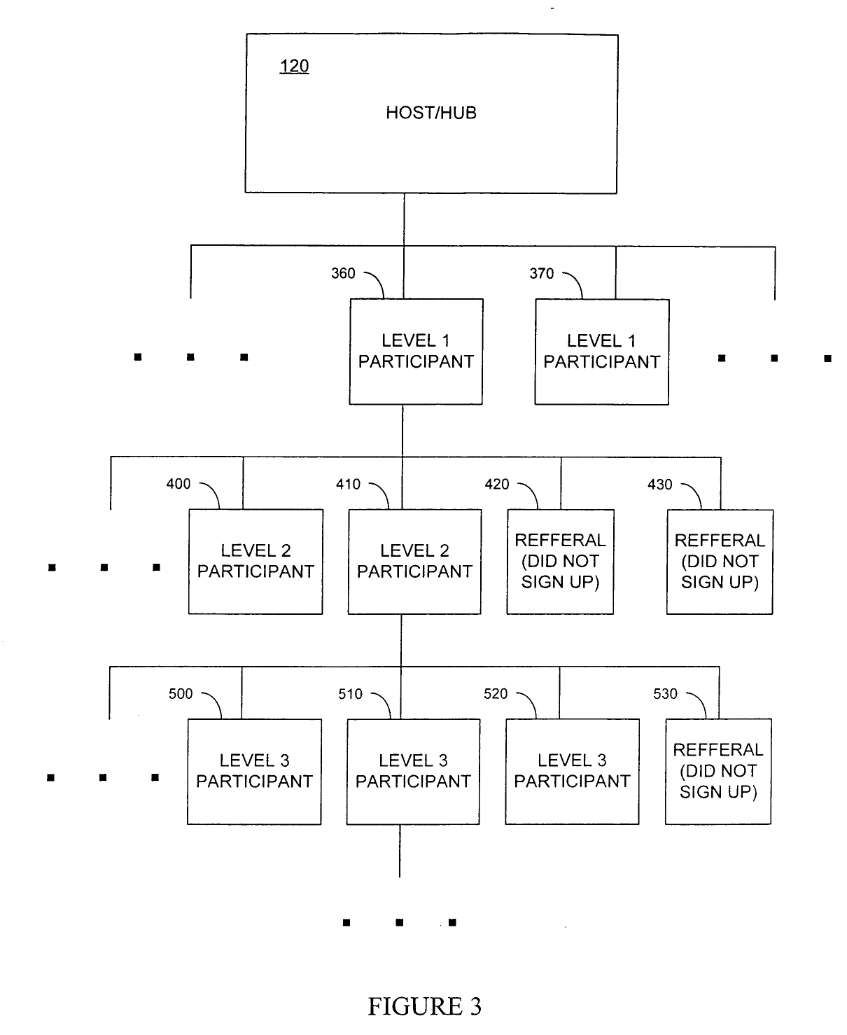

Once the Host/Hub 120 receives into its Account 130 the portion of the revenue from the Partner 210 (step 260), it provides a portion of that revenue to the Participant in the form of credits. Specifically, credits are credited to the Participant's Account 340 (step 270). As will be further described below with respect to FIG. 3, in the preferred embodiment of the present invention, the provision of credits to the Participant's Account 130 is subject to multilevel distribution. As with the revenue sharing between the Partners 210 and the Host/Hub 120, the conversion of revenue received by the Host/Hub 120 into credits for the Participants 300 is governed by the agreement between the Host/Hub 120 and the Participants 300. In the preferred embodiment of the present invention, the Participants 300 receive a percentage of the revenue realized by the Host/Hub 120 in the form of credits. For example, in one embodiment the Participants 300 can receive 50% (the “sharing rate”) of the revenue received by the Host/Hub 120 from the Partner 210. Additionally, there is preferably a fixed conversion rate from dollars to credits, for example, one dollar can equal one point or one dollar can equal five credits. Given a 50% sharing agreement and one dollar/one point conversion rate, in the above camera sale example where the Host/Hub 120 receives $10 from the Partner 210, the Host/Hub 120 will credit the Participant Account 340 with five credits for the purchase (subject to the multilevel distribution and redemption described below).

The sharing rate at which the Host/Hub 120 shares the revenues with the Participant 300 may be altered based upon changes in the volume of Qualified Activities undertaken by the Participant. This volume may contractually increase or decrease the sharing rate between the Host/Hub 120 and the Participants 300 and its referred Participants as discussed below. The volume of Qualified Activities may be readily measured based upon credits to the Participant Account 340. Host/Hub 120 revenues may increase directly with the volume of Qualified Activities. Host/Hub 120 profit margins increase with the additional buying, selling and marketing power generated by the Participant 300 cumulative Qualified Activities. The Host/Hubs 120, Partner 210 and Participants 300 all benefit from the economies of scale and size deriving from the methods and systems of the present invention.

In addition to the Partners 210 offering goods or services, the Host/Hubs 120 themselves may directly offer various goods, services and sales, marketing and promotional vehicles. Participants 300 conducting Qualified Activities (e.g. purchases) at a Host/Hub 120 or Partner 210 site directly share in both the Host/Hub 120 revenue, benefits and any revenues or benefits accruing to other Participants 300 referred by said Participant 300 to said Host/Hub 120 as described below. Once the revenue and benefits have accrued to the Participant Accounts' 340, they may be redeemed for any legal form of currency, or substitute thereof (e.g., credits for purchases at Partner 210 sites) at any time for any legal use, including, without limitation, subsequent transactions, bill paying, charitable contributions, lottery entries and micro-payments. In a preferred embodiment of the present invention, when redeeming credits, the Participant's credits in Account 340 are converted back into dollars or any other form of legal currency or substitute thereof at the same rate at which the revenue (dollars) was converted into credits for deposit in the Account 340. After redemption, the redeemed credits are deducted from the Participant's Account 340. The Host/Hub 120 is responsible for the maintenance of the Participant Accounts 340 and provides the Participant 300 with online summary and transaction history with respect to the Accounts 340.

The methodology of the present invention applies to all legal forms of commerce, including, without limitation: (1) business-to-business, business-to-consumer, business-to-government, and consumer-to-consumer transactions; (2) online, offline and hybrid commerce platforms; (3) all sizes of transactions, including Micro-Payments and large scale commercial transactions (on a sliding scale); or (4) other such applications as may be practiced. As used herein, the term consumer is intended to encompass consuming businesses and government entities as well as individuals. Partners 210 benefit directly by increased sales volume from the activities of Participants 300. Partners 210 further benefit from improved marketing exposure. Participants 300 benefit directly by building credit in Accounts 340 that can be applied at any time, in any venue, in any legal manner. Credits in Accounts 340 may be universally applied (after conversion to dollars if necessary) to credit card accounts, redeemed by draft check, transferred as bill payments, exchanged for promotional credits, transposed into lottery entries and be put to virtually any other legal use. Participants' 300 benefits increase with the additional buying, selling and marketing power generated by the cumulative Qualified Activities of their fellow Participants 300.

FIG. 3 depicts the multilevel structure of the revenue (point) sharing by Participants. In addition to receiving credits for making purchases or performing other Qualified Activities themselves directly, Participants receive credits for the Qualified Activities of each subsequent Participant that the original Participant signs up to the system of the present invention. As described above, an unsolicited visitor to the Host/Hub 120, may enroll in the program, establish an Account 340 and receive an ID 305 (FIG. 2) and thus becoming a “Level 1” Participant 360, 370. In order to expand the Participant pool, Level 1 Participants 360, 370 introduce other unknown parties to the Host/Hub 120 (the parties are previously unknown to the Host/Hub 120). The introduction is preferably made via an accountable method such as through an E-mail through the Host/Hub 120 or some other mechanism such that the Host/Hub 120 can verify that the Level 1 Participant 360-370 initiated the introduction. Furthermore, Host/Hub 120 can keep track of the referrals to prohibit someone from registering as a new Participant in order to subvert the multilevel credit sharing of the present invention.

If the introduced visitor registers with the Host/Hub 120, he/she is assigned an Account 340 and an ID 305 and thus becomes a “Level 2” Participant 400, 410. As seen in FIG. 3, Level 1 Participant 360 made at least four introductions (referrals). Two of the introduced visitors registered to become Level 2 Participants 400, 410, while two did not choose to register, visitors 420 and 430. Although not explicitly depicted in FIG. 3, each of the Level 1 Participants 360, 370 can have several referrals that did not register, and several Level 2 Participants that did register and are structurally placed in the level below the Level 1 Participants 360, 370.

When the Level 2 Participant, e.g. Participant 410, engages in Qualified Activities, a portion of the Level 2 Participant's credits is credited to the Level 1 Participant's Bank Account (e.g., the Account 340 of Participant 360). In this manner a linkage is created between the various Participants in the multiple levels of the structure of the present invention. This linkage applies to any prior and subsequent introductions a specific Participant makes. It is appreciated that linkages between N levels of Participants is made possible by this structure, where “N” is any positive number (“N”). A portion of the credits from the N levels of Participants accrete to the Accounts 340 of the levels above a specific Participant. The appeal of this structure is that Level 1 Participants (e.g. Participant 360) earn Credits when their Level 2 Participants (e.g. Participants 400, 410) engage in Qualified Activities. The desire to engage or not to engage in Qualified Activities, whether through the Host/Hub 120 or otherwise (e.g. directly through Partners 210), is entirely in the Participant's discretion and control. The Host/Hub 120 and its Partners 210 set prices in their own discretion and control, effectively creating the most free and efficient of marketplaces. In alternative embodiment of the present invention, credits can accrete downwards, i.e., a portion of the credits achieved by a higher level Participant are shared with lower level Participants.

FIG. 3 illustrates a specific example of the multilevel structure of the present invention. An introduction results when a Level 1 Participant 360, generates an e-mail or other introduction to an unknown visitor 400-430. In a specific embodiment, introduction occurs when the Level 1 Participant 360 provides the Host/Hub 120 with the E-mail address of the unknown visitors 400-430. The Host/Hub 120 then sends an e-mail inviting the unknown visitors 400-430 to visit the Host/Hub 120. The invitation may include information regarding the reason for the invitation, a description of the program and its terms, the e-mail address of the Level 1 Participant 360 who made the Introduction, and the means to return to the Host/Hub 120 to register to become a Participant (e.g. a link in the E-mail to the Host/Hub 120 web site). If the unknown visitor 400-430 responds to the Level 1 Participant's 360 introduction or the invitation, registers and establishes an Account 340 with the Host/Hub 120 for the first time, the Level 1 Participant 360 has linkage to the thus-created Level 2 Participants 400, 410. If the visitor does not register with the Host/Hub 120, no linkage is created, and the unknown visitor 420, 430 remains an unregistered visitor.

Introductions may be made repeatedly by the Level 1 Participant 360. Should this process ultimately result in a linkage, Host/Hub 120 benefits earned by the Level 2 Participants 400, 410 (e.g., credits) partially accrete to the Account 340 of the Level 1 Participant 360, effectively resulting in a pool of Participants that benefits, along with the Host/Hub 120 and its Partners 210, from economies of scale and size.

At the next level, the linkage process begins again as the Level 2 Participants 400, 410 make introductions to other unknown visitors, which may result in the unknown visitors registering with the Host/Hub 120. As seen in FIG. 3, Level 2 Participant 410 caused introductions to be sent to unknown visitors 500-530. Three of the visitors 500, 510 or 520 registered with the Host/Hub 120 thus creating a linkage and becoming Level 3 Participants (with respect to the Level 1 Participant 360). The Level 2 Participant 410 making such introductions essentially becomes a Level 1 participant with respect to the Participants 500, 510 or 520. As the Level 3 Participants 500, 510 or 520 earn credits, a portion of the those credits accrete to the Account 340 of the Level 2 Participant 410 and a portion of those credits accrete to the Level 1 Participant 360. In one embodiment of the present invention, there is a limit as to how many levels credits will accrete, e.g., two levels.

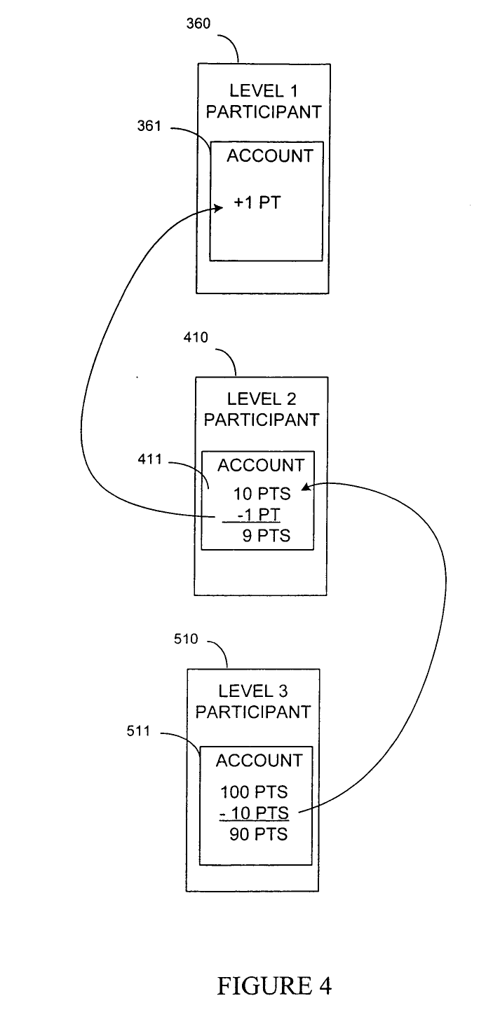

An example of point sharing according to the present invention is illustrated in FIG. 4. It is assumed for illustration in this example that the accretion is set at a ten percent level (i.e., ten percent of the credits earned by a Participant accrete to the next higher level Participant). As shown in this Figure, the Level 3 Participant 510 has earned 100 credits by performing a Qualified Activity (e.g., making a purchase from a Partner 210). Ten percent of those credits, or 10 credits are deducted from the Account 511 of Participant 510 and credited to the Account 411 of the Level 2 Participant 410. Continuing up the multilevel structure, ten percent of the credits credited to Participant 410, (i.e., one point) is credited to the Account 361 of the Level 1 Participant 360. Thus for the 100 credits earned, the Level 3 Participant 510 receives 90 credits, the Level 2 Participant 410 receives 9 credits and the Level 1 Participant 360 receives 1 point.

The credits available for distribution are subject to the Participants' sharing arrangement agreed to when the Participants join the system. The sharing arrangement allocates the sharing of available Credits among the Participants based upon which specific Participant is generating the credits and the number of levels linked to the credits generated. In the scenario where a Level 1 Participant (e.g., 360, 370 in FIG. 3) generates the credits and has no higher Participant levels tied to self-generated credits, the Level 1 Participant 360, 370 may receive all of the 100 Credits from his or her own Qualified Activities. In the second scenario, where a Level 2 Participant 400, 410 or a Level 3 Participant 500, 510 or 520 is the Participant conducting the Qualified Activity generating the credits, and the sharing arrangement details how the credits are shared with the levels above the generating Participant.

In addition to the above described benefits to the Participants, the benefit to the Host/Hub 120 and its Partners 210 is the rapid, viral scaling of the number and activity of Participants, and of the introductions to unknown visitors who may become Participants. When the Participants undertake Qualified Activities to build credits in their Accounts 340, the Host/Hub 120 and its Partners 210 generate increased revenue from the Qualified Activities such as increased sales and marketing volume. The Participants benefit by the additional buying, selling and marketing power generated by their cumulative Qualified Activities.

To redeem credits, a Participant may conduct transactions with the Host/Hub 120 or its Partners 210. Alternatively, the Participant can request a direct redemption of credits for cash in the form of a check or credit (electronic) to another account of the Participant (e.g. bank, credit card or store account). The Host/Hub 120 can offer incentives, including the potential to earn additional credits, as a means to encourage Participants to spend credits within the system (e.g., at the Host/Hub 120 or one of its Partners 210).

Upon a request to redeem credits in connection with a Host/Hub 120 or Partner 210 transaction (e.g. a purchase), the Host/Hub 120 confirms the balance of credits in the Participant's Account 340. If the point balance is sufficient, the Host/Hub 120 makes a transfer payment based on the point conversion rate as a credit to the transaction. The credits so utilized are debited from the Account 340, thus completing the Host/Hub's 120 contribution to the transaction.

In connection with transactions through non-Hub/Host 120 venues, the Host/Hub 120 may charge a service fee in connection with certain transaction (e.g., crediting third party credit and debit card accounts, issuing draft checks, making micro-payments or other such redemption activities). The Host/Hub 120 may also generate revenue from financial processes and practices, including service fees and interest earned on Account balances.

The Host/Hub 120 can accommodate payments for low cost “Micro-payments” by processing the payments through Accounts 340. Micro-payments can be made to Partners 210 through established settlement methods with the Partner or with other third parties via draft check, electronic transfer or any other legal form of currency. An example of such a Micro-payment might be for electronically viewing pages of a document for which the charge is two cents per page viewed.

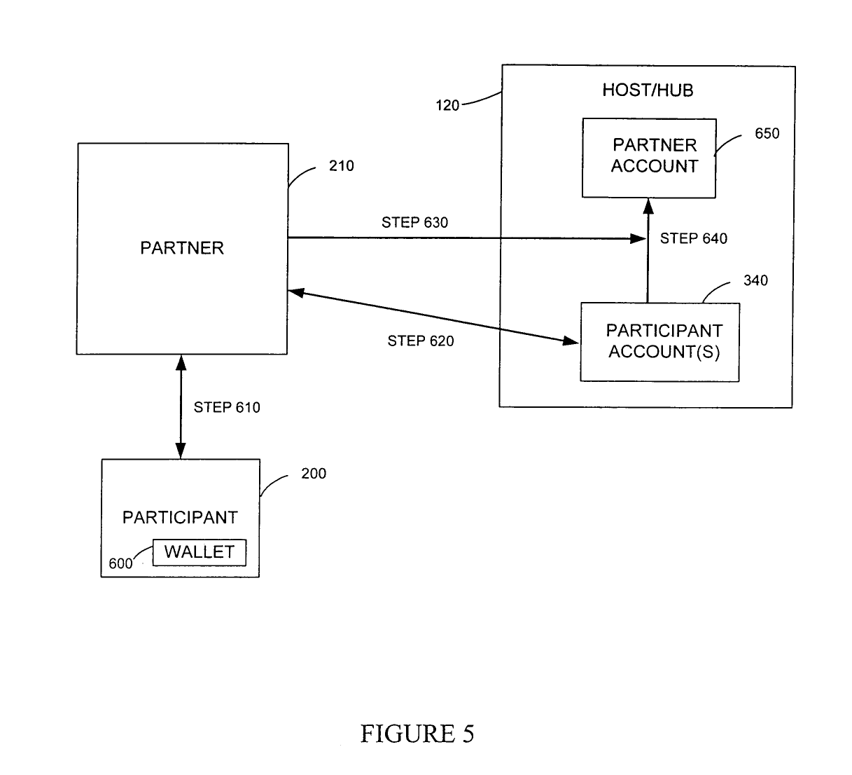

FIG. 5 illustrates an embodiment of the present invention that enables Micro-payment processing as well as redemption of credits against purchases made at Partner sites. For Micro-payments as well as regular payments using credits, the Participant is provided with an electronic Wallet 600. In a preferred embodiment, the Wallet 600 provides a link to the Participant's Account 340 at the Host/Hub 120 by which the Partner 210 can verify the balance in the Account 340. Alternatively, the Wallet 600 can be digitally impressed with a point value from which Partners 210 can deduct value. The point value impressed on the Wallet 600 can only be increased by the Host/Hub 120.

In step 610 in FIG. 5, Participant 200 performs a Qualified Activity by engaging in an activity that requires a Micro-payment to Partner 210. As part of completing the transaction, in step 620, Partner 210 reads the balance of the Participant's Account 340 in order to verify that the Account 340 contains sufficient credits to complete the transaction. If there are sufficient credits, the Partner 210 directs the Host/Hub 120 in step 630 to transfer the amount of the payment (e.g., a Micro-payment or a redemption of credits for a purchase) from the Participant's Account 340 to the Partner's Account 650 held at the Host/Hub 120. In step 640, the Host/Hub 120 performs the transfer. At the end of the day, week, month or other period agreed upon with the Partner 210, the Host/Hub 120 performs a settlement of the Partner's Account 650 with respect to other revenues and transactions occurring between the Host/Hub 120 and Partner 210.

In the alternative wallet embodiment, the Partner 210 reads the balance of credits digitally impressed into the Participant's Wallet 600. If there are sufficient credits on the Wallet 600, the Partner 210 deducts the credits associated with the payment from the Wallet 600. This step results in the Wallet 600 issuing a certificate representing the deduction. In step 630, the Partner transfers the certificate representing the deduction to the Host/Hub 120 in response to which the Host/Hub 120 credits the Partner's Account 650 with the amount of the payment (credits). Again, settlement between the Partner 210 and the Host/Hub 120 occurs on an agreed upon schedule.

If the Participant's Wallet 600 is near depletion, or has an insufficient balance of credits, the Participant 360 is prompted by a message with an electronic tag and link to return to the Host/Hub 120 to replenish the Wallet 600. The message informs Participant 360 of its remaining available balance of credits in its Wallet 600 and advises Participant 360 to replenish its Wallet 600. If Participant 360 does not replenish and fully depletes the Wallet 600, the Participant 360 is returned automatically to the Host/Hub 120 with an electronic tag which includes a link back to the point of exit from Partner 210. Upon Participant's 360 arrival at the Host/Hub 120, the electronic tag prompts the Host/Hub 120 to generate a message (“Return/Exit Message”) with a choice to return to his prior activity at Partner 210 (a routing to replenish and return to Partner 210 at the site of departure), or exit and remove the electronic tag.

The Return/Exit Message asks Participant 360 to take an action, such as replenishing his Wallet 600. If the Participant 360 chooses this option, the Participant 360 can transfer credits from its Account 340 to its Wallet 600. After the replenishment, the Host/Hub 120 uses the electronic tag to route Participant 360 back to Partner 210 at the spot at which the Participant 360 left. Alternatively, Participant 360 can choose an exit option on the Return/Exit Message which abandons the electronic tag.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

We claim:

1. A method for operating a system for Internet multilevel sales comprising the steps of:
registering a participant as a first level participant;
the first level participant referring an entity to the system;
registering the entity as a second level participant;
one of the first and second level participant performing an activity;
awarding credits to the participant that performed the activity; and
transferring to the first level participant a portion of the credits if the second level participant was awarded the credits.

2. The method as recited in claim 1, wherein the step of performing the activity further comprises making a purchase.

3. The method as recited in claim 2, wherein the purchase is made on the Internet.

4. The method as recited in claim 1, wherein a plurality of partners are associated with the system, the partners offering goods and services, wherein the step of performing the activity further comprises performing the activity in cooperation with at least one of the partners.

5. The method as recited in claim 4, further comprising the step of the at least one partner providing a fee to an operator of the system in response to the performance of the activity.

6. The method as recited in claim 5, wherein the fee is based on revenue received by the at least one partner from the performance of the activity.

7. The method as recited in claim 1, wherein the step of performing the activity further comprises paying for a service.

8. The method as recited in claim 1, wherein the step of performing the activity further comprises the referring step.

9. The method as recited in claim 1, wherein the step of performing the activity further comprises viewing advertising.

10. The method as recited in claim 1, wherein the step of performing the activity further comprises visiting an Internet website.

11. The method as recited in claim 1, wherein the step of performing the activity further comprises participating in a survey.

12. The method as recited in claim 1, wherein the step of performing the activity further comprises participating in a poll.

13. The method as recited in claim 1, further comprising the step of establishing an account for each participant.

14. The method as recited in claim 13, further comprising the step of depositing the awarded credits in the account of the participant, and wherein the step of transferring further comprises the step of transferring the portion of the credits from an the account of the second level participant to the account of the first level participant.

15. The method as recited in claim 1, further comprising the steps of:
the second level participant referring a second entity to the system;
registering the second entity as a third level participant;
the third level participant performing another activity;
awarding credits to the third level participant;
transferring to the second level participant a portion of the credits awarded to the third level participant; and
transferring to the first level participant a portion of the credits transferred to the second level participant.

16. The method as recited in claim 1, further comprising the step of redeeming the credits for cash.

17. The method as recited in claim 1, further comprising the step of applying the credits to an activity performed by the participant.

18. The method as recited in claim 17, wherein the activity is a purchase.

19. The method as recited in claim 17, further comprising the step of storing the credits in an electronic wallet, wherein step of applying the credits to an activity performed by the participant further comprises using the credits stored in the electronic wallet.

20. The method as recited in claim 19, further comprising the steps of:
depleting the credits stored on the electronic wallet while visiting a partner website;
visiting a website of the system and storing more credits on the electronic wallet; and
automatically returning to the partner website.

21. The method as recited in claim 1, wherein an amount of the awarded credits is related to revenue received by an operator of the system in connection with the performed activity.

22. The method as recited in claim 1, wherein the first level participant is an individual.

23. The method as recited in claim 1, wherein the first level participant is a business.

24. A method for operating a system for Internet multilevel sales comprising the steps of:
registering a participant as a first level participant;
the first level participant sending invitations, using the system, to a plurality of entities, the invitations inviting the plurality of entities to register with the system;
registering at least one of the entities as a second level participant;
one of the first and second level participant performing an activity, the activity being one of a plurality of activities recognized by the system;
awarding credits to the participant that performed the activity; and
transferring to the first level participant a portion of the credits if the second level participant was awarded the credits.

25. The method as recited in claim 24, wherein the portion of the credits transferred to the first level participant from the second level participant is determined according to a sharing rate.

26. The method as recited in claim 25, wherein sharing rate is a fixed rate.

27. The method as recited in claim 25, wherein sharing rate is a variable rate.

28. The method as recited in claim 26, wherein variable rate is dependent on the volume of activities performed.

29. The method as recited in claim 24, wherein awarding step further comprises awarding the credits to the participant at a fixed rate.

30. The method as recited in claim 24, wherein awarding step further comprises awarding the credits to the participant on a sliding scale.
